(19) United States
(12) Patent Application Publication
(10) Pub. No.: US 2010/0249332 A1
(43) Pub. Date: Sep. 30, 2010

(54) BIODEGRADABLE POLYESTER COPOLYMERS

(75) Inventor: Patrick J. Ferguson, Portland, OR (US)

Correspondence Address: SHERIDAN ROSS PC, 1560 BROADWAY, SUITE 1200, DENVER, CO, 80202, US

(73) Assignee: WRIGHT & MCGILL CO., Denver, CO (US)

(21) Appl. No.: 12/744,664

(22) PCT Filed: Jul. 16, 2009
(86) PCT No.: PCT/US09/50912

§ 371 Date: May 25, 2010

Related U.S. Application Data
(60) Provisional application No. 61/081,389, filed on Jul. 16, 2008.

(51) Int. Cl. B29C 47/08; C08L 67/04; C08L 67/02

(52) U.S. Cl. 525/284; 264/176.1; 264/211.12; 525/301

(57) ABSTRACT

In accordance with embodiments provided herein, biodegradable filament suitable for use as fishing line and/or fishing net prepared from a polyester copolymer is provided. Embodiments of biodegradable filament is prepared from a polymer blend comprising from about 60% by weight to about 99.9% by weight of polybutylene succinate (PBS) and from about 0.1% by weight to about 40% by weight of a second polymer selected from the group consisting of polycaprolatone (PCL), polyglycolic acid (PGA), and polylactic acid (PLA).

### FIELD

The present invention is related to biodegradable polyester copolymers, and more particularly, compounds and methods for making products made therefrom.

### BACKGROUND

Most available fishing line and netting is made of synthetic polymer resin filament. Monofilament fishing line is a single-strand, strong, flexible filament that is clear or tinted in a variety of colors. Synthetic polymer monofilament, such as made from nylon, is non-biodegradable and can take over 500 years to decompose. Because it is thin and often clear, it is very difficult for fish, birds and animals to see, and they can easily brush up against it and become entangled in it. Once entangled, they may become injured, drown, get strangled or starve to death. What is needed is a filament that is functional as fishing line and netting as well as biodegradable so as to minimize the impact on the environment.

### SUMMARY

Biodegradable filament prepared from a polymer blend comprising from about 60% by weight to about 99.9% by weight of polybutylene succinate (PBS) and from about 0.1% by weight to about 40% by weight of polycaprolatone (PCL) characterized by high tensile strength and knot strength is provided.

Biodegradable filament prepared from a polymer blend comprising from about 80% by weight to about 90% by weight of polybutylene succinate (PBS) and from about 10% by weight to about 20% by weight polycaprolatone (PCL) characterized by high tensile strength and knot strength is provided.

Biodegradable filament prepared from a polymer blend comprising from about 60% by weight to about 99.9% by weight of polybutylene succinate (PBS) and from about 0.1% by weight to about 40% by weight of polyglycolic acid (PGA) characterized by high tensile strength and knot strength is provided.

Biodegradable filament prepared from a polymer blend comprising from about 80% by weight to about 90% by weight of polybutylene succinate (PBS) and from about 10% by weight to about 20% by weight of polyglycolic acid (PGA) characterized by high tensile strength and knot strength is provided.

Biodegradable filament prepared from a polymer blend comprising from about 60% by weight to about 99.9% by weight of polybutylene succinate (PBS) and from about 0.1% by weight to about 40% by weight of polylactic acid (PLA) characterized by high tensile strength and knot strength is provided.

Biodegradable filament prepared from a polymer blend comprising from about 80% by weight to about 90% by weight of polybutylene succinate (PBS) and from about 10% by weight to about 20% by weight of polylactic acid (PLA) characterized by high tensile strength and knot strength is provided.

Biodegradable filament prepared from a polymer blend comprising from about 60% by weight to about 99.9% by weight of polybutylene succinate (PBS) and from about 0.1% by weight to about 40% by weight of a second polymer which is selected from the group consisting of polycaprolatone (PCL), polyglycolic acid (PGA), and polylactic acid (PLA) characterized by high tensile strength and knot strength is provided.

Biodegradable filament prepared from a polymer blend comprising from about 80% by weight to about 90% by weight of polybutylene succinate (PBS) and from about 10% by weight to about 20% by weight of a second polymer which is selected from the group consisting of polycaprolatone (PCL), polyglycolic acid (PGA), and polylactic acid (PLA) characterized by high tensile strength and knot strength is provided.

### BRIEF DESCRIPTION OF THE DRAWINGS

Embodiments are illustrated by way of example and not by way of limitation in the figures of the accompanying drawings, in which like references may indicate similar elements throughout the various figures unless otherwise specified.

FIG. 1 is a flow diagram of embodiments of methods for producing biodegradable filament.

### DETAILED DESCRIPTION

In the following description, embodiments of apparatus and methods will be disclosed. For purposes of explanation, specific numbers, materials, and/or configurations are set forth in order to provide a thorough understanding of the embodiments. However, it will also be apparent to those skilled in the art that the embodiments may be practiced without one or more of the specific details, or with other approaches, materials, components, etc. In other instances, well-known structures, materials, and/or operations are not shown and/or described in detail to avoid obscuring the embodiments. Accordingly, in some instances, features are omitted and/or simplified in order to not obscure the disclosed embodiments. Furthermore, it is understood that the embodiments shown in the figures are illustrative representations and are not necessarily drawn to scale.

Reference throughout this specification to “one embodiment” or “an embodiment” means that a particular feature, structure, or characteristic described in connection with the embodiment is included in at least one embodiment of claimed subject matter. Thus, the appearances of the phrase “in one embodiment” or “an embodiment” in various places throughout this specification are not necessarily all referring to the same embodiment. Furthermore, the particular features, structures, or characteristics may be combined in one or more embodiments.

Reference will now be made to embodiments illustrated in the drawings and specific language which will be used to describe the same. It will nevertheless be understood that no limitation of the scope of the invention is thereby intended. Alterations and further modifications of the illustrated embodiments and further applications of the principles of the invention, as would normally occur to one skilled in the art to which the invention relates, are also within the scope of the invention.

For the purposes of the subject matter disclosed herein, reference to biodegradable refers to a material capable of undergoing decomposition into carbon dioxide, methane, water, inorganic compounds, or biomass in which the predominant mechanism is the enzymatic action of microorganisms that can be measured by standardized tests, in a specified period of time, reflecting available disposal condition. Where a biodegradation process is sufficient to mineralize organic matter into carbon dioxide or methane, water and biomass, the material can be deemed biodegradable.

Raw polyester resin components suitable for embodiments provided herein may be obtained from a number of international suppliers.

In accordance with embodiments presented herein, a monofilament is provided suitable for use as fishing line and/or fishing netting that is prepared from a polyester copolymer which has suitable strength that is biodegradable.

In particular implementations, biodegradable filament of embodiments provided herein are prepared from a polymer blend having from about 60% by weight to about 99.9% by weight of polybutylene succinate and from about 0.1% by weight to about 40% by weight of a second polymer selected from the group consisting of polycaprolatone (PCL), polyglycolic acid (PGA), and polylactic acid (PLA).

In other embodiments, biodegradable filament is prepared from a polymer blend having from about 80% by weight to about 90% by weight of polybutylene succinate (PBS) and from about 20% by weight to about 10% by weight of a second polymer selected from the group consisting of polycaprolatone (PCL), polyglycolic acid (PGA), and polylactic acid (PLA).

The filament of embodiments provided herein have a surprisingly greater tensile strength than a filament comprising polybutylene succinate biodegradable polyester polymer alone. In addition, other properties of the resulting filament, such as the energy required to break the filament in straight pull tests and in knot pull tests, are significantly improved by the addition of the second polymer in ways that make the resulting filament particularly suitable for its intended purpose. Knot retention is also improved as well as handleability and castability from the fishing pole. It is understood that the monofilament fishing line and netting as provided in the embodiments presented herein will be significantly biodegraded after about two years of exposure to the natural bacteria in the natural environment of a river or stream.

PBS-PLA Filament

Embodiments herein provide a polyester copolymer having a polyester moiety comprising about 60 to 99.9 molar % of polybutylene succinate (PBS) and about 40 to 0.1 molar % of polylactic acid (PLA), referred herein as PBS-PLA copolymer. In accordance with embodiments a biodegradable filament comprising PBS-PLA copolymer as provided above is provided.

In accordance with embodiments, biodegradable fishing line comprising PBS-PLA copolymer as provided above is prepared from a polymer blend comprising from about 80% by weight to about 90% by weight of polybutylene succinate (PBS) and from about 10% by weight to about 20% by weight of polylactic acid (PLA).

In yet other embodiments, netting suitable for the fishing trade comprising the above PBS-PLA copolymer filament is anticipated.

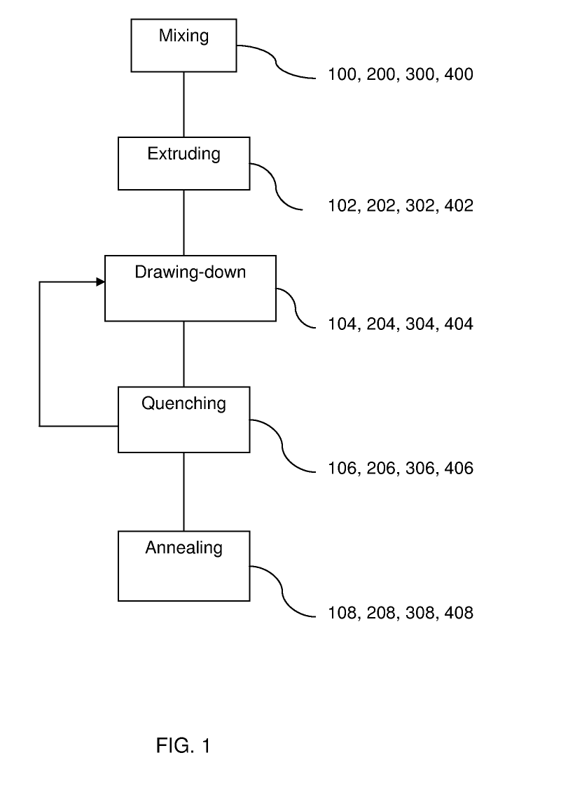

FIG. 1 is a flow diagram of embodiments of methods for producing biodegradable filament, such as for producing fishing line and fishing netting, comprising PBS-PLA copolymer. The PBS-PLA copolymer is prepared from a polymer blend comprising from about 80% by weight to about 90% by weight of polybutylene succinate (PBS) and from about 10% by weight to about 20% by weight of polylactic acid (PLA). The PBS and PLA resin, such as in the form of, but not limited, to solid pellets, are mixed in a hopper and raised to a temperature of between about 210 to 230 degrees C. forming a liquid copolymer resin mixture 100. The copolymer resin mixture is extruded through a die using techniques well known in the art 102. By way of example, for a 0.22 mm diameter final filament diameter, the die may have an exit diameter of about 0.39 mm, such that after a number of drawdown processes, the resulting filament diameter is about 0.22 mm. After extrusion, the filament is processed by a number of drawdown processes at a temperature of about between 35 to 150 degrees C., and preferably 100 to 110 degrees C. 104. Drawdown is the known process of pulling the extrudate at a faster rate then it is being extruded or released from a spool so as to stretch the extrudate to reduce the filament diameter and orient the polymer chains, among other things. In embodiments, 5 to 8 drawdown steps are performed to achieve the desired diameter and physical properties of strength and flexibility suitable for use as fishing line and fishing netting. In other embodiments, the filament may be quenched between each drawdown step 106. In other embodiments, a final annealing process at about between 35 to 150 degrees C., and preferably 100 to 110 degrees C., without drawdown is performed 108.

PBS-PGA Filament

Embodiments herein provide a polyester copolymer having a polyester moiety comprising about 60 to 99.9 molar % of polybutylene succinate (PBS) and about 40 to 0.1 molar % of polyglycolic acid (PGA), referred herein as PBS-PGA copolymer. In accordance with embodiments a biodegradable filament comprising PBS-PGA copolymer as provided above is provided.

In accordance with embodiments, biodegradable fishing line comprising PBS-PGA copolymer as provided above is prepared from a polymer blend comprising from about 80% by weight to about 90% by weight of polybutylene succinate (PBS) polyester polymer and from about 10% by weight to about 20% by weight of polyglycolic acid (PGA).

In yet other embodiments, netting suitable for the fishing trade comprising the above PBS-PGA copolymer filament is anticipated.

FIG. 1 is a flow diagram of embodiments of methods for producing biodegradable filament, such as for producing fishing line and fishing netting, comprising PBS-PGA copolymer. The PBS-PGA copolymer is prepared from a polymer blend comprising from about 80% by weight to about 90% by weight of polybutylene succinate (PBS) polyester polymer and from about 10% by weight to about 20% by weight of polyglycolic acid (PGA). The PBS and PGA resin, such as in the form of, but not limited, to solid pellets, are mixed in a hopper and raised to a temperature of between about 210 to 230 degrees C. forming a liquid copolymer resin mixture 200. The copolymer resin mixture is extruded through a die using techniques well known in the art 202. By way of example, for a 0.22 mm diameter final filament diameter, the die may have an exit diameter of about 0.39 mm, such that after a number of drawdown steps, the resulting filament diameter is about 0.22 mm. After extrusion, the filament is processed by a number of drawdown processes at a temperature of about between 35 to 150 degrees C., and preferably 100 to 110 degrees C. 204. Drawdown is the known process of pulling the extrudate at a faster rate then it is being extruded or released from a spool so as to stretch the extrudate to reduce the filament diameter and orient the polymer chains, among other things. In embodiments, 5 to 8 drawdown steps are performed to achieve the desired diameter and physical properties of strength and flexibility suitable for use as fishing line and fishing netting. In other embodiments, the filament may be quenched between each drawdown step 206. In other embodiments, a final annealing process at about between 35 to 150 degrees C., and preferably 100 to 110 degrees C., without drawdown is performed 208.

PBS-PCL Filament

Embodiments herein provide a polyester copolymer having a polyester moiety comprising about 60 to 99.9 molar % of polybutylene succinate (PBS) and about 40 to 0.1 molar % of polycaprolatone (PCL), referred herein as PBS-PCL copolymer. In accordance with embodiments a biodegradable filament comprising PBS-PCL copolymer as provided above is provided.

In accordance with embodiments, biodegradable fishing line comprising PBS-PCL copolymer as provided above is prepared from a polymer blend comprising from about 80% by weight to about 90% by weight of polybutylene succinate (PBS) and from about 10% by weight to about 20% by weight of polycaprolatone (PCL).

In yet other embodiments, netting suitable for the fishing trade comprising the above PBS-PCL copolymer filament is anticipated.

FIG. 1 is a flow diagram of embodiments of methods for producing biodegradable filament, such as for producing fishing line and fishing netting, comprising PBS-PCL copolymer. The PBS-PCL copolymer is prepared from a polymer blend comprising from about 80% by weight to about 90% by weight of polybutylene succinate (PBS) and from about 10% by weight to about 20% by weight of polycaprolatone (PCL). The PBS and PCL resin, such as in the form of, but not limited, to solid pellets, are mixed in a hopper and raised to a temperature of between about 210 to 230 degrees C. forming a liquid copolymer resin mixture 300. The copolymer resin mixture is extruded through a die using techniques well known in the art 302. By way of example, for a 0.22 mm diameter final filament diameter, the die may have an exit diameter of about 0.39 mm, such that after a number of drawdown steps, the resulting filament diameter is about 0.22 mm. After extrusion, the filament is processed by a number of drawdown processes at a temperature of about between 35 to 150 degrees C., and preferably 100 to 110 degrees C. 304. Drawdown is the known process of pulling the extrudate at a faster rate then it is being extruded or released from a spool so as to stretch the extrudate to reduce the filament diameter and orient the polymer chains, among other things. In embodiments, 5 to 8 drawdown steps are performed to achieve the desired diameter and physical properties of strength and flexibility suitable for use as fishing line and fishing netting. In other embodiments, the filament may be quenched between each drawdown step 306. In other embodiments, a final annealing process at about between 35 to 150 degrees C., and preferably 100 to 110 degrees C., without drawdown is performed 308.

PBS-PLA+PCL Filament

Embodiments herein provide a polyester copolymer having a polyester moiety comprising about 80% by weight to about 90% by weight of polybutylene succinate (PBS) and from about 10% by weight to about 20% by weight of a combination of polylactic acid (PLA) and polycaprolatone (PCL), referred herein as PBS-PLA+PCL copolymer. In accordance with embodiments a biodegradable filament comprising PBS-PGA copolymer as provided above is provided.

In accordance with embodiments, biodegradable fishing line comprising PBS-PLA+PCL copolymer as provided above is prepared from a polymer blend comprising from about 80% by weight to about 90% by weight of polybutylene succinate (PBS) and from about 10% by weight to about 20% by weight of a combination of polylactic acid (PLA) and polycaprolatone (PCL).

In yet other embodiments, filament suitable for fishing line and netting suitable for the fishing trade comprising the above PBS-PLA+PCL copolymer filament is anticipated.

FIG. 1 is a flow diagram of embodiments of methods for producing biodegradable filament, such as for producing fishing line and fishing netting, comprising PBS-PLA+PCL copolymer. The PBS-PLA+PCL copolymer is prepared from a polymer blend comprising from about 80% by weight to about 90% by weight of polybutylene succinate (PBS) polyester polymer and from about 10% by weight to about 20% by weight of polylactic acid (PLA) and polycaprolatone (PCL) combination. The PBS and PLA+PCL resin, such as in the form of, but not limited, to solid pellets, are mixed in a hopper and raised to a temperature of between about 210 to 230 degrees C. forming a liquid copolymer resin mixture 400. The copolymer resin mixture is extruded through a die using techniques well known in the art 402. By way of example, for a 0.22 mm diameter final filament diameter, the die may have an exit diameter of about 0.39 mm, such that after a number of drawdown steps, the resulting filament diameter is about 0.22 mm. After extrusion, the filament is processed by a number of drawdown processes at a temperature of about between 35 to 150 degrees C., and preferably 100 to 110 degrees C. 404. Drawdown is the known process of pulling the extrudate at a faster rate then it is being extruded or released from a spool so as to stretch the extrudate to reduce the filament diameter and orient the polymer chains, among other things. In embodiments, 5 to 8 drawdown steps are performed to achieve the desired diameter and physical properties of strength and flexibility suitable for use as fishing line and fishing netting. In other embodiments, the filament may be quenched between each drawdown step 406. In other embodiments, a final annealing process at about between 35 to 150 degrees C., and preferably 100 to 110 degrees C., without drawdown is performed 408.

It is appreciated that the monofilament filament, as used as fishing line and fishing netting, as provided in the embodiments herein will be significantly biodegraded after about two years of exposure to the natural bacteria in the natural environment of a river or stream.

Example: Fishing line produced using about 80% by weight PBS and 20% PLA.

TABLE 1
Test Data of fishing line produced using about 80% by weight
PBS and 20% PLA.

| | | Straight | Knot |
|---|---|---|---|
| | Diameter | (Lbs.- | (Lbs.- |
| LB Test | (mm) | force) | force) |
| 4LB | 0.22 | 4.08 | 3.22 |
| 6LB | 0.28 | 6.80 | 5.49 |
| 8LB | 0.32 | 8.69 | 7.13 |
| 10LB | 0.36 | 10.52 | 8.59 |
| 12LB | 0.40 | 13.00 | 10.39 |

Table 1 presents the results of pull to failure tests for various diameter monofilament fishing line produced from the copolymer as described above. Standard straight pull test and a standard knot test were performed for a number of line diameters. The pull tests were performed on an Instron material testing machine, Instron, Norwood, Mass. A 0.22 mm diameter line was pulled to failure at 4.08 lbs for straight line and 3.22 lbs. for the knot. A 0.28 mm diameter line was pulled to failure at 6.8 lbs for straight line and 5.49 lbs. for the knot. A 0.32 mm diameter line was pulled to failure at 8.69 lbs for straight line and 7.13 lbs. for the knot. A 0.36 mm diameter line was pulled to failure at 10.52 lbs for straight line and 8.59 lbs. for the knot. A 0.40 mm diameter line was pulled to failure at 13 lbs for straight line and 10.39 lbs. for the knot.

For comparison, for a nylon monofilament line having a diameter of 0.22 mm, a typical knot pull test measurement is about 1.5 lbs. Fishing line produced in accordance with the present embodiments significantly better performance over standard fishing line while producing a product that naturally biodegrades.

Biodegradable Copolymer Reel/Spool/Bobbin

Embodiments provided herein provide a reel/spool/bobbin suitable for having fishing line and the like wrapped thereon prepared from a polyester copolymer compound which has sufficient strength and is biodegradable. Biodegradable reels of the present embodiments are prepared from a polymer blend having from about 90% by weight to about 95% by weight of polybutylene succinate, from about 5% by weight to about 10% by weight of a second polymer selected from the group consisting of polycaprolactane (PCL), polyglycolic acid (PGA), and polylactic acid (PLA).

Other embodiments provide a reel/spool/bobbin suitable for having fishing line and the like wrapped thereon prepared from a polyester copolymer compound which has sufficient strength and is biodegradable. Biodegradable reels of the present embodiments are prepared from a polymer blend having from about 90% by weight to about 95% by weight of polybutylene succinate, from about 5% by weight to about 10% by weight of a second polymer selected from the group consisting of polycaprolactane (PCL), polyglycolic acid (PGA), and polylactic acid (PLA), and from about 1% by weight to about 20% by weight talc.

In other embodiments, biodegradable reels of the present embodiments are prepared from a polymer blend having from about 80% by weight to about 90% by weight of polybutylene succinate and from about 20% by weight to about 10% by weight of a second polymer selected from the group consisting of polycaprolactane (PCL), polyglycolic acid (PGA), polylactide and polylactic acid (PLA), and from about 1% by weight to about 20% by weight talc.

Reels of the present embodiments have a strength particularly suitable for its intended purpose while retaining the property of biodegradability.

While the invention has been described in connection with specific embodiments thereof, it will be understood that it is capable of further modification, and this application is intended to cover any variations, uses, or adaptations of the invention following, in general, the principles of the invention and including such departures from the present disclosure as come within known or customary practice in the art to which the invention pertains and as may be applied to the essential features hereinbefore set forth, and as fall within the scope of the invention and the limits of the appended claims.

1-8. (canceled)

9. A method for producing biodegradable filament comprising:
providing a polymer blend comprising from about 80% by weight to about 90% by weight of polybutylene succinate (PBS) and from about 10% by weight to about 20% by weight of polylactic acid (PLA);
mixing the PBS and PLA at a temperature of between about 210-230 degrees C. forming a liquid copolymer resin mixture;
extruding the copolymer resin mixture through a die forming a filament; and
drawing-down the filament at a temperature of about between 35-150 degrees C. one or more times to achieve a desired diameter and physical properties of strength and flexibility suitable for use as fishing line and/or fishing netting.

10. The method of claim 9, further comprising:
quenching the filament between each drawdown.

11. The method of claim 10, further comprising:
annealing the filament at a temperature of about between 35-150 degrees C.

12. The method of claim 10, further comprising:
annealing the filament at a temperature of about between 100-110 degrees C.

13. The method of claim 9, wherein drawing-down the filament at a temperature of about between 35 to 150 degrees C. comprises drawing-down the filament at a temperature of about between 100-110 degrees C.

14. A method for producing biodegradable filament comprising:
providing a polymer blend comprising from about 80% by weight to about 90% by weight of polybutylene succinate (PBS) and from about 10% by weight to about 20% by weight of polyglycolic acid (PGA);
mixing the PBS and PGA at a temperature of between about 210-230 degrees C. forming a liquid copolymer resin mixture;
extruding the copolymer resin mixture through a die forming a filament; and
drawing-down the filament at a temperature of about between 35-150 degrees C. one or more times to achieve a desired diameter and physical properties of strength and flexibility suitable for use as fishing line and/or fishing netting.

15. The method of claim 14, further comprising:
quenching the filament between each drawdown.

16. The method of claim 15, further comprising:
annealing the filament at a temperature of about between 35-150 degrees C.

17. The method of claim 15, further comprising:
annealing the filament at a temperature of about between 100-110 degrees C.

18. The method of claim 14, wherein drawing-down the filament at a temperature of about between 35 to 150 degrees C. comprises drawing-down the filament at a temperature of about between 100-110 degrees C.

19. A method for producing biodegradable filament comprising:
providing a polymer blend comprising from about 80% by weight to about 90% by weight of polybutylene succinate (PBS) and from about 10% by weight to about 20% by weight of polycaprolatone (PCL);
mixing the PBS and PCL at a temperature of between about 210-230 degrees C. forming a liquid copolymer resin mixture;
extruding the copolymer resin mixture through a die forming a filament; and
drawing-down the filament at a temperature of about between 35-150 degrees C. one or more times to achieve a desired diameter and physical properties of strength and flexibility suitable for use as fishing line and/or fishing netting.

20. The method of claim 19, further comprising:
quenching the filament between each drawdown.

21. The method of claim 19, further comprising:
annealing the filament at a temperature of about between 35-150 degrees C.

22. The method of claim 19, further comprising:
annealing the filament at a temperature of about between 100-110 degrees C.

23. The method of claim 19, wherein drawing-down the filament at a temperature of about between 35 to 150 degrees C. comprises drawing-down the filament at a temperature of about between 100-110 degrees C.

24. A method for producing biodegradable filament comprising:
providing a polymer blend comprising from about 80% by weight to about 90% by weight of polybutylene succinate (PBS) and from about 10% by weight to about 20% by weight of a combination of polylactic acid (PLA) and polycaprolatone (PCL);
mixing the PBS, PLA and PCL at a temperature of between about 210-230 degrees C. forming a liquid copolymer resin mixture;
extruding the copolymer resin mixture through a die forming a filament;
drawing-down the filament at a temperature of about between 35-150 degrees C. one or more times to achieve a desired diameter and physical properties of strength and flexibility suitable for use as fishing line and/or fishing netting.

25. The method of claim 24, further comprising
quenching the filament between each drawdown.

26. The method of claim 25, further comprising:
annealing the filament at a temperature of about between 35-150 degrees C.

27. The method of claim 25, further comprising annealing the filament at a temperature of about between 100-110 degrees C.

28. The method of claim 24, wherein drawing-down the filament at a temperature of about between 35 to 150 degrees C. comprises drawing-down the filament at a temperature of about between 100-110 degrees C.

29. (canceled)

30. (canceled)

31. A biodegradable filament prepared from a polymer blend comprising from about 60% by weight to about 99.9% by weight of polybutylene succinate (PBS) and from about 0.1% by weight to about 40% by weight of a second polymer selected from a group consisting of at least one of polycaprolatone (PCL), polyglycolic acid (PGA), and polylactic acid (PLA).

32. The biodegradable filament of claim 31, wherein the second polymer is polycaprolatone (PLC).

33. The biodegradable filament of claim 31 comprising from about 80% by weight to about 90% by weight of polybutylene succinate (PBS) and from about 10% by weight to about 20% by weight polycaprolatone (PLC).

34. The biodegradable filament of claim 31, wherein the second polymer is polyglycolic acid (PGA).

35. The biodegradable filament of claim 31 comprising from about 80% by weight to about 90% by weight of polybutylene succinate (PBS) and from about 10% by weight to about 20% by weight polyglycolic acid (PGA).

36. The biodegradable filament of claim 31, wherein the second polymer is polylactic acid (PLA).

37. The biodegradable filament of claim 31 comprising from about 80% by weight to about 90% by weight of polybutylene succinate (PBS) and from about 10% by weight to about 20% by weight polylactic acid (PLA).

38. The biodegradable filament of claim 31 comprising from about 80% by weight to about 90% by weight of polybutylene succinate (PBS) and from about 10% by weight to about 20% by weight of the second polymer selected from the group consisting of at least one of polycaprolatone (PCL), polyglycolic acid (PGA), and polylactic acid (PLA).

39. The biodegradable filament of claim 31 comprising from about 80% by weight to about 90% by weight of polybutylene succinate (PBS) and from about 10% by weight to about 20% by weight of a combination of polylactic acid (PLA) and polycaprolatone (PLC).
